(19) United States
(12) Patent Application Publication
(10) Pub. No.: US 2023/0051533 A1
(43) Pub. Date: Feb. 16, 2023

(54) WIRE HARNESS MANUFACTURING DEVICE

(71) Applicant: Yazaki Corporation, Tokyo (JP)

(72) Inventors: Takahito SAITOU, Makinohara-shi (JP); Jun Yagi, Makinohara-shi (JP); Tetsuo Iwao, Susono-shi (JP)

(73) Assignee: Yazaki Corporation, Tokyo (JP)

(21) Appl. No.: 17/884,302

(22) Filed: Aug. 9, 2022

(30) Foreign Application Priority Data
Aug. 10, 2021 (JP) 2021-130721

(51) Int. Cl. H01B 13/012; H01R 43/20

(52) U.S. Cl. CPC H01B 13/01236; H01R 43/20; H01B 13/01209; H01B 13/01263

(57) ABSTRACT

A wire harness manufacturing device includes a first rail and a second rail provided in parallel on a jig plate; a first holding portion that holds a first connector and a second holding portion that holds a second connector; an electric wire holding portion that holds a first electric wire and a second electric wire; a one end side connection portion that connects one end sides of the first electric wire and the second electric wire to the first connector and the second connector; a cutting portion that cuts the first electric wire and the second electric wire; the other end side connector that connects the cut first electric wire and the cut second electric wire to a third connector and a fourth connector and a binding portion that binds the first electric wire and the second electric wire whose tension is adjusted.

### CROSS REFERENCE TO RELATED APPLICATIONS

This application is based on and claims priority from Japanese patent application No. 2021-130721 filed on Aug. 10, 2021, the entire contents of which are incorporated herein by reference.

### TECHNICAL FIELD

The present invention relates to a wire harness manufacturing device.

### BACKGROUND ART

As an example, the wire harness is manufactured through a step of measuring an electric wire, a step of cutting the electric wire to a predetermined length, a step of press-clamping a terminal to an end of the cut electric wire, a step of inserting the electric wire with the terminal into a connector, and a step of binding a plurality of electric wires with the connector at a predetermined position and forming a product shape. Patent Literature 1 mainly discloses a technique relating to a step of forming a product shape.
Patent Literature 1 is JP-A-2018-60643.

Among wire harness manufacturing steps, a device automatically performs an electric wire measuring step to a connector insertion step. In the step of forming a product shape, the operator arranges a plurality of electric wires on a dedicated jig plate, forms a branch at a predetermined position, and binds the electric wires. In this way, since processing is performed manually for each product, it is difficult to shorten a cycle time for manufacturing one wire harness.

### SUMMARY OF INVENTION

A wire harness manufacturing device shortens a cycle time for manufacturing a wire harness.

A wire harness manufacturing device includes

a jig plate;

a first rail and a second rail that are provided in parallel on the jig plate;

a first holding portion that is configured to hold a first connector and that is movable along the first rail, and a second holding portion that is configured to hold a second connector and that is movable along the second rail;

an electric wire holding portion configured to hold a first electric wire pulled out from a first reel and a second electric wire pulled out from a second reel;

a one end side connection portion configured to connect one end side of each of the first electric wire and the second electric wire to a respective one of the first connector and the second connector;

a cutting portion configured to cut the first electric wire pulled out to a first predetermined position by a movement of the first holding portion and the second electric wire pulled out to a second predetermined position by a movement of the second holding portion;

a third holding portion and a fourth holding portion configured to hold a third connector and a fourth connector, respectively;

the other end side connector configured to connect the other end sides of the cut first electric wire and the cut second electric wire to the third connector and the fourth connector, respectively; and

a binding portion configured to bind the first electric wire and the second electric wire at a predetermined position,

wherein the binding portion is configured to bind the first electric wire and the second electric wire whose tension is adjusted by at least the first holding portion moving along the first rail.

According to the wire harness manufacturing device in one of embodiments of the present invention, a cycle time for manufacturing a wire harness can be shortened.

### BRIEF DESCRIPTION OF DRAWINGS

The present invention has been briefly described above. Further, details of the present invention will be clarified by reading a mode (hereinafter, referred to as an “embodiment”) for carrying out the invention to be described below with reference to the accompanying drawings.

FIG. 1 is a schematic plan view showing a wire harness manufacturing device according to an embodiment of the present invention;

FIG. 2 shows a state in which a one end side holding portion provided with a connector is moved to a processing position in the wire harness manufacturing device in FIG. 1;

FIG. 3 shows a state in which the one end side holding portion holding the connector, to which one end side of an electric wire is crimped, is moved to a predetermined position in the wire harness manufacturing device in FIG. 1;

FIG. 4 shows a state in which the electric wire is cut in the wire harness manufacturing device in FIG. 1;

FIG. 5 shows a state in which the other end side of the electric wire is crimped to the connector held by the other end side holding portion in the wire harness manufacturing device in FIG. 1;

FIG. 6 shows a state in which a plurality of electric wires are converged by a robot hand in the wire harness manufacturing device in FIG. 1; and

FIG. 7 shows a state in which a plurality of electric wires are tape wound in the wire harness manufacturing device in FIG. 1.

### DESCRIPTION OF EMBODIMENTS

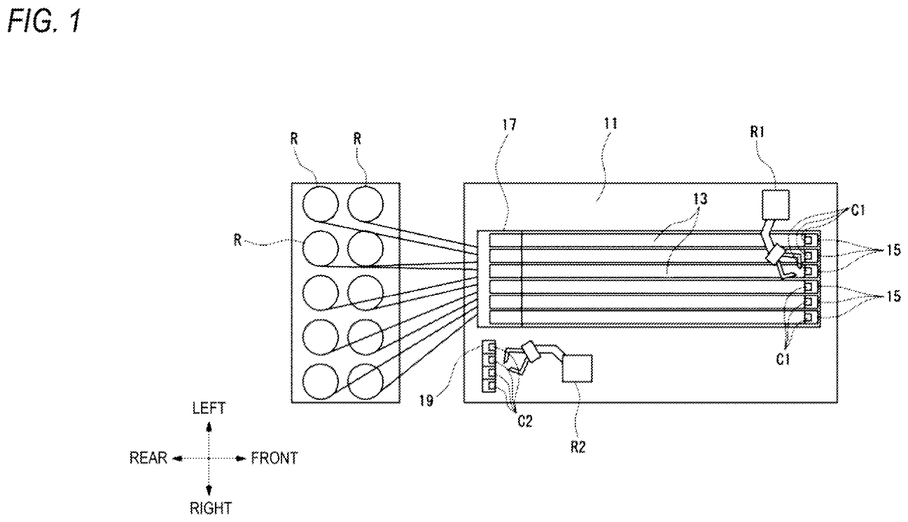

A specific embodiment of the present invention will be described below with reference to the drawings. FIG. 1 is a schematic plan view showing a wire harness manufacturing device according to an embodiment of the present invention. The wire harness manufacturing device is a fully automated machine that collectively and automatically performs an electric wire cutting step, a connector crimping step, a wire harness product shape forming step, and an inspection step. Hereinafter, for convenience of description, as shown in FIG. 1, “front”, “rear”, “left”, and “right” are defined. A “front-rear direction”, a “left-right direction”, and an “upper-lower direction” are orthogonal to one another.

The wire harness manufacturing device shown in FIG. 1 includes a plurality of electric wire reels R, a jig plate 11, a plurality of rails 13, a plurality of one end side holding portions 15, a pressing mechanism 17, the other end side holding portion 19, and two robot arms R1, R2, and the entire wire harness manufacturing device is controlled by a control device (not shown). The plurality of electric wire reels R correspond to a first reel and a second reel, the plurality of rails 13 correspond to the first rail and the second rail, the plurality of one end side holding portions 15 correspond to a first holding portion and a second holding portion, and the other end side holding portion 19 corresponds to a third holding portion and a fourth holding portion. The pressing mechanism 17 corresponds to an electric wire holding portion, a one end side connecting portion, a cutting portion, and the other end side connecting portion.

The plurality of electric wire reels R are arranged in a plurality of rows in an accommodation place. In the pressing mechanism 17, the plurality of electric wires pulled out from the plurality of electric wire reels R pass through a nip portion formed by two rollers in a state of being arranged in parallel, and are sent out from electric wire nozzles.

The jig plate 11 is a rectangular plate provided on a front side of the electric wire reel R. The jig plate 11 is provided with the pressing mechanism 17, the plurality of rails 13, the plurality of one end side holding portions 15, the other end side holding portion 19, and the robot arms R1, R2.

The plurality of rails 13 extend from the front end of the jig plate 11 to a rear end where the pressing mechanism 17 is located along the front-rear direction on the jig plate 11, and are arranged in parallel to one another. In the present embodiment, six rails 13 are provided, and the one end side holding portion 15 is slidably provided on each rail 13.

Each of the plurality of one end side holding portions 15 includes a slide portion that is slidable relative to the rail 13, and a connector holding portion that holds a connector C1 (a first connector and a second connector). The connector holding portion of the one end side holding portion 15 is picked up by the robot arm R1, and holds the connector C1 placed from above by, for example, a pair of grip portions. The plurality of one end side holding portions 15 move from a front end of the rail 13, which is an initial position, to a rear end by the slide portion. The one end side holding portions 15 convey the connector C1 to which an electric wire W is connected at the rear end of the rail 13 to predetermined positions (a first predetermined position and a second predetermined position). The predetermined position is a position based on an electric wire length of the electric wire W, and by this conveyance, the electric wire W is pulled out by an amount corresponding to a required electric wire length from the electric wire reel R. Each of the one end side holding portions 15 includes an inspection probe configured to execute a conduction inspection on a circuit formed by crimping and connecting the electric wire W to the connector C1.

At least a part of the plurality of one end side holding portions 15 is formed with a branch at the plurality of electric wires W. When the plurality of electric wires W are bundled by tape winding, tension of one or more electric wires W is adjusted by moving the one or more electric wires W along the corresponding rail 13.

In the one end side holding portion 15, the connector holding portion rotates about a normal direction (a direction perpendicular to a paper surface in FIG. 1) of a slide surface relative to the slide portion, and the connector holding portion may be rotated when the tension is adjusted. The connector holding portion rotates relative to the slide portion and a terminal insertion hole of the connector faces a binding portion. Accordingly, it is possible to prevent a root of the electric wire inserted into the connector from being bent.

The other end side holding portion 19 includes a plurality of connector holding portions that hold the plurality of connectors C2 (a third connector and a fourth connector), and a slider that moves the connector holding portions from a right side toward a left side on a rear side of the jig plate 11 toward the pressing mechanism 17. The other end side holding portion 19 can change an interval between the plurality of connector holding portions, and can adjust an arrangement interval of the plurality of connectors C2. The connector holding portion of the other end side holding portion 19 is picked up by the robot arm R2 and holds the connector C2 placed from above by, for example, suction. In the other end side holding portion 19, the plurality of connector holding portions are arranged in a row along the left-right direction, and the plurality of connectors C2 are collectively set by the robot arm R2. The other end side holding portion 19 is movable in the front-rear direction in a state in which the connector holding portion is moved to the pressing mechanism 17, and can move the plurality of connectors C2 arranged in a row in the left-right direction in the front-rear direction.

Each of the connector C1 and the connector C2 is a known connector including a crimping terminal capable of crimping the electric wire W and a housing accommodating the crimping terminal. The housing is pressed in a state in which the end portion of the electric wire W is inserted into the housing, so that the electric wire W is electrically connected to the crimping terminals of the connectors C1, C2. At least one electric wire W is connected to each of the connector C1 and the connector C2.

The pressing mechanism 17 is provided behind the jig plate 11. The pressing mechanism 17 includes an electric wire holding mechanism that holds a plurality of electric wires W pulled out from the plurality of reels R in parallel, and a crimping mechanism that collectively crimps one end side of each of the plurality of electric wires W to a respective one of the plurality of connectors C1. The pressing mechanism 17 also includes an electric wire cutting mechanism that collectively cuts a plurality of electric wires W pulled out to a predetermined length. The electric wire cutting mechanism is provided on a front side of the nip portion, and includes, as an example, a plurality of cutting blades that cut the plurality of electric wires W, and a plurality of electric wire end holding portions that hold the electric wire ends at a front side of the cutting blades.

The press mechanism 17 includes a pitch conversion mechanism that converts a pitch of the plurality of electric wires into a wide pitch corresponding to the plurality of connectors C1 and a narrow pitch corresponding to the plurality of connectors C2. The pitch conversion mechanism converts the pitch of the plurality of electric wires W by moving the plurality of electric wire end holding portions in the left-right direction.

The press mechanism 17 includes an electric wire correction mechanism including a comb-shaped jig having a plurality of comb teeth and a mechanism that drives the comb-shaped jig. The electric wire correction mechanism corrects a tendency of the electric wire W by arranging each of the comb teeth between the plurality of electric wires W and causing the electric wire W to slide.

The press mechanism 17 includes a crimping mechanism that collectively crimps each of the other end sides (cut end portions) of the plurality of electric wires W, each of which is cut to a predetermined length and has a narrow pitch, to a respective one of the plurality of connectors C2. The crimping mechanism is provided in a vicinity of the electric wire correction mechanism, and crimps the connector C2 to the other end side of the electric wire W corrected by the electric wire correction mechanism.

The press mechanism 17 is provided with an inspection probe configured to execute a conduction inspection on a circuit formed by crimping and connecting the electric wire W to the connector C2.

The robot arm R1 is a six-axis robot provided with, at a distal end portion thereof, a gripping mechanism that picks up the plurality of connectors C1 one by one and a hand H1 that converges the plurality of electric wires W. The robot arm R1 can move the distal end portion to any position on the jig plate 11 according to a program incorporated in a control device, and can drive the gripping mechanism and the hand H1 that are mounted on the distal end portion. The robot arm R1 grips one connector C1 from, for example, the plurality of connectors C1 supplied to a right front side of the jig plate 11 by the gripping mechanism, transfers the one connector C1 above the connector holding portion of the one end side holding portion 15 on the jig plate 11, and disposes the connector C1 on the connector holding portion. Further, when forming a branch in the plurality of electric wires W, the robot arm R1 picks the plurality of electric wires W at a predetermined position on the jig plate 11 by the hand H1. That is, the hand H1 bundles the plurality of electric wires W into a bundle in an unfixed state.

A robot arm R2 is a six-axis robot provided with, at a distal end portion thereof, a gripping mechanism that collectively picks up the plurality of connectors C2 arranged in a row and a tool H2 that tape winds and binds the plurality of electric wires W. The robot arm R2 can move the distal end portion to any position on the jig plate 11 according to the program incorporated in the control device, and can drive the gripping mechanism and the tool H2 that are mounted on the distal end portion. The robot arm R2 collectively grips the plurality of connectors C2 arranged in a row on the right front side of the jig plate 11 by a gripping mechanism, transfers the plurality of connectors C2 above the connector holding portion of the other end side holding portion 19 on the jig plate 11, and disposes the connector C2 on the connector holding portion. The robot arm R2 forms a branch by winding and binding a tape around the plurality of electric wires W at a predetermined position on the jig plate 11 by the tool H2. The robot arm R2 winds, by the tool H2, the tape around an outer periphery of the plurality of electric wires W in a state of being converged by the hand H1 of the robot arm R1.

Wire harness manufacturing steps that are performed by the wire harness manufacturing device implemented as described above will be described with reference to FIGS. 1 to 7. The following manufacturing steps are performed by operating the robot arms R1, R2, the plurality of one end side holding portions 15, the other end side holding portion 19, and the pressing mechanism 17 according to the program incorporated in the control device of the wire harness manufacturing device.

Preparation

In the wire harness manufacturing device, the plurality of connectors C1 and the plurality of connectors C2 are prepared in advance on the right front side of the jig plate 11. One end sides of the plurality of electric wires W pulled out from the plurality of electric wire reels R are held by the electric wire holding mechanism of the pressing mechanism 17 in a state of being arranged in parallel.

Collective Supply of Connectors C1, C2

First, as shown in FIG. 1, the robot arm R1 grips the plurality of connectors C1, and transfers and sets each connector C1 to a respective one of the plurality of one end side holding portions 15. Further, the robot arm R2 grips the plurality of connectors C2, collectively transfers the plurality of connectors C2 to the other end side holding portion 19, and sets the plurality of connectors C2 to a right rear side of the jig plate 11.

Collectively Crimping Connector C1 to One End Side of Electric Wire W

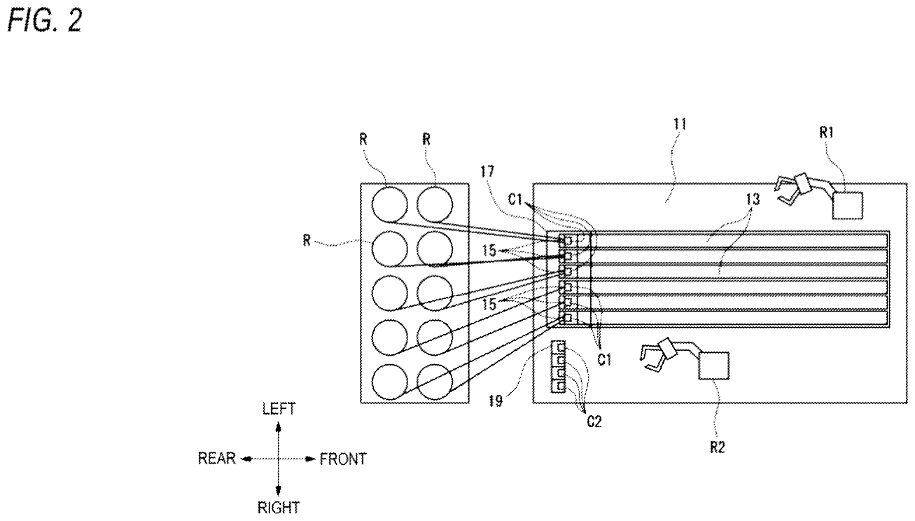

Each of the plurality of one end side holding portions 15 slides on a respective one of the rails 13 and conveys a respective one of the connectors C1 to a processing position shown in FIG. 2. At this processing position, the electric wire holding mechanism of the pressing mechanism 17 nips the one end sides of the plurality of electric wires W and sends the plurality of electric wires W forward, and inserts each of the one end sides of the plurality of electric wires W into a respective one of the connectors C1. The crimping mechanism of the pressing mechanism 17 crimps, to the connector C1, the electric wire W of which the one end side is accommodated in the housing of the connector C1.

Pulling Out Plurality of Electric Wires W by Necessary Dimension and Collectively Measuring Electric Wires W

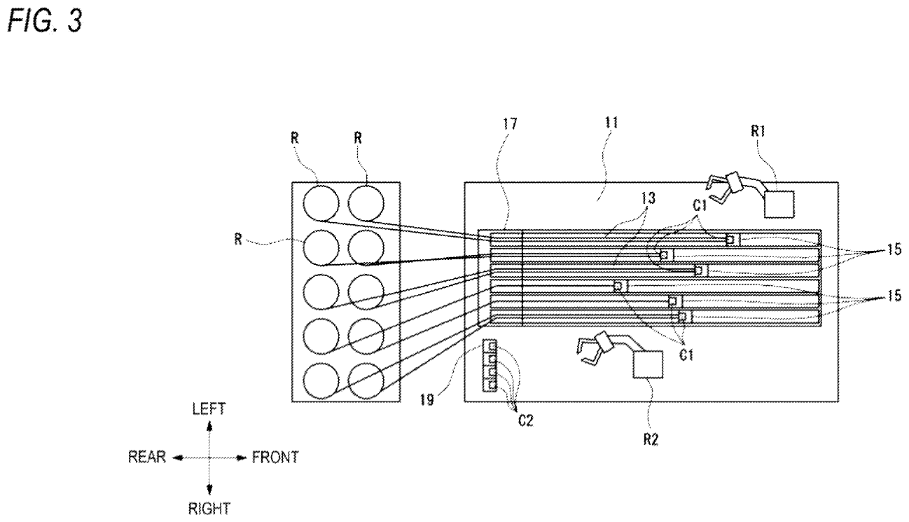

As shown in FIG. 3, the plurality of one end side holding portions 15 slide on the rails 13 to convey, to the predetermined positions, the connectors C1 to which the one end sides of the electric wires W are crimped. Each of the one end side holding portions 15 is conveyed to a respective one of the predetermined positions, so that each electric wire W is pulled out from a respective one of the electric wire reels R by a necessary length. In this way, the plurality of electric wires W are collectively measured.

Collectively Cutting Electric Wires W

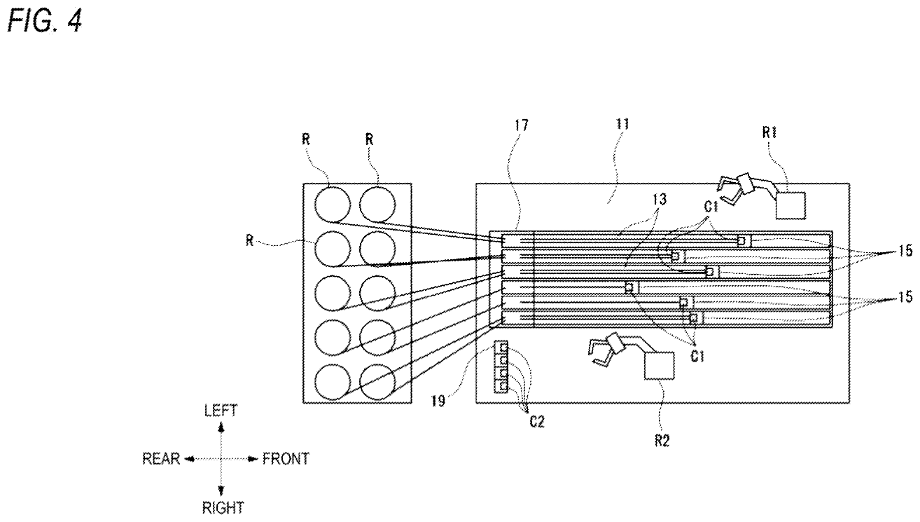

As shown in FIG. 4, the electric wire cutting mechanism of the pressing mechanism 17 collectively cuts the plurality of electric wires W each pulled out by a respective one of the necessary lengths. The other end sides of the plurality of cut electric wires W are held by the plurality of electric wire end holding portions. The measuring and the cutting of the plurality of electric wires W described above correspond to a wiring step in normal wire harness manufacturing.

Collectively Crimping Connector C2 to the Other End Side of Electric Wire W

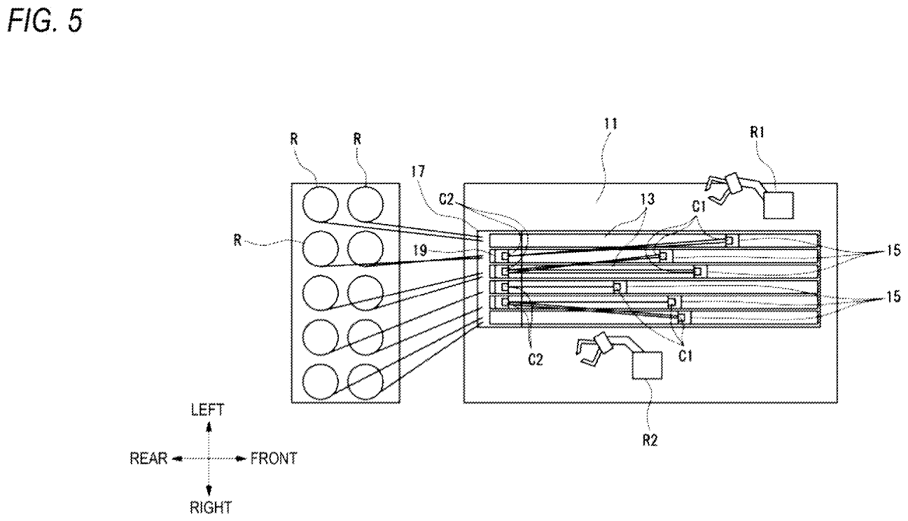

Next, the slider of the other end side holding portion 19 conveys the plurality of connectors C2 to a left side, and disposes the plurality of connectors C2 at the processing position as shown in FIG. 5. The other end side holding portion 19 adjusts the interval between the plurality of connectors C2. The pitch conversion mechanism of the pressing mechanism 17 moves the plurality of electric wire end holding portions in the left-right direction to convert the pitch of the plurality of electric wires W from the pitch of the connector C1 to the pitch of the connector C2. The plurality of electric wires W after the pitch conversion are provided in front of the plurality of connectors C2. The pressing mechanism 17 corrects the tendency of the other end sides of the plurality of pitch converted electric wires W by the electric wire correction mechanism. At this time, the other end side holding portion 19 moves forward to move the plurality of connectors C2 forward, and the other end sides of the electric wires W are inserted into the predetermined connectors C2. Thereafter, the crimping mechanism of the pressing mechanism 17 crimps, to the connector C2, the electric wire W of which the other end side is accommodated in the housing of the connector C2.

Conduction Inspection

After the connector C2 is crimped to the other end side of the electric wire W, an inspection probe of the one end side holding portion 15 and an inspection probe of the pressing mechanism 17 are inserted into the connectors C1, C2, respectively, and the control device executes conduction inspection of the circuit formed by crimping and connecting each of the connectors C1, C2 to a respective one of both ends of the electric wire W. The control device, the inspection probe of the one end side holding portion 15, and the inspection probe of the pressing mechanism 17 constitute a conduction inspection unit. If an error occurs as a result of the conduction inspection, an error notification such as an alarm sound is issued by the control device. The inspection unit is provided in each of the pressing mechanism 17 and the one end side holding portion 15, and connectivity of the circuit on the jig plate 11 is checked immediately after the circuit formation. Accordingly, it is possible to immediately respond to the conduction error.

Forming Branch

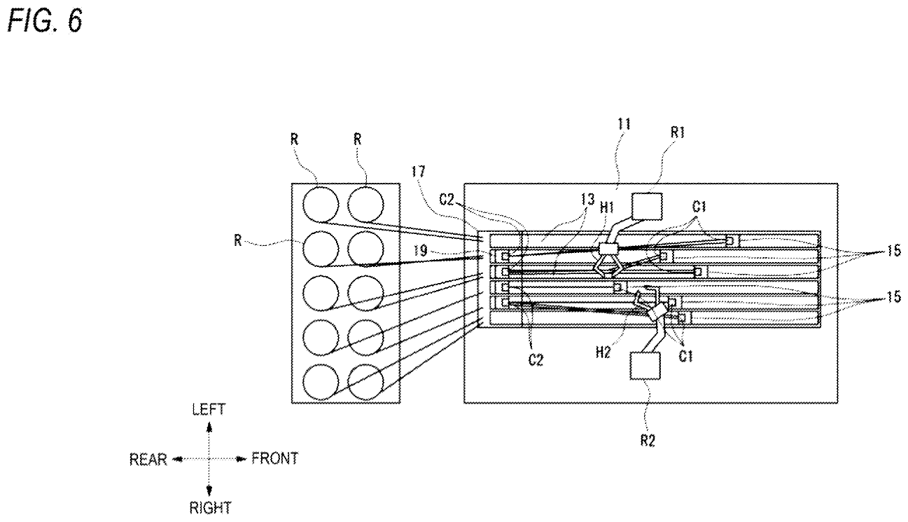

After passing the conduction inspection, as shown in FIG. 6, the robot arm R1 converges the specified electric wire W among the plurality of electric wires W at a predetermined position (a binding position) by the hand H1. The binding position is determined based on each length from the one end side of a respective one of the electric wires W to which the connector C1 is attached. At a time of the convergence of the electric wire W, at least a part of the plurality of one end side holding portions 15 moves along the corresponding rail 13 in the front-rear direction, thereby adjusting tension of one or more electric wires W.

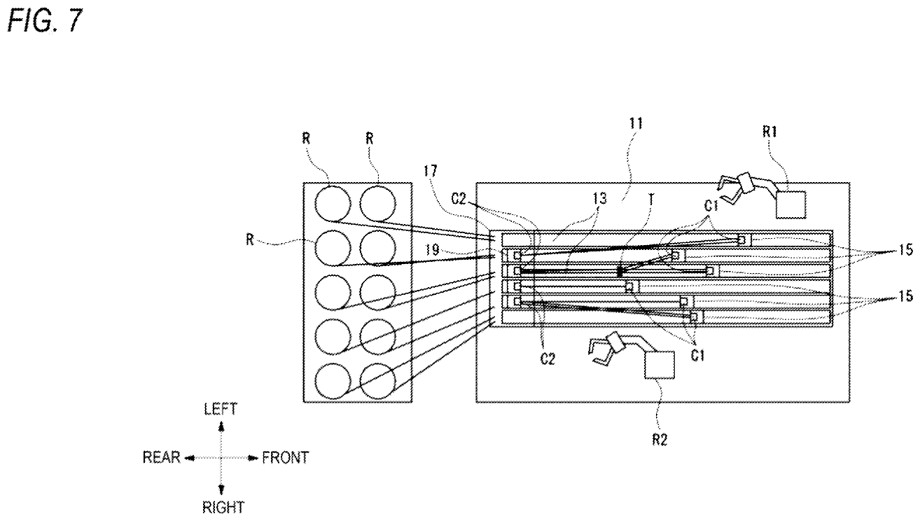

Subsequently, as shown in FIG. 7, the robot arm R2 winds a tape around the converged electric wire W by the tool H2 to form a branch. In the tension adjustment of the electric wire W, for example, before the hand H1 converges the plurality of electric wires W, the one end side holding portion 15 is moved forward to loosen the electric wire W, so that the electric wire W can be easily picked. The electric wire W is loosened by moving the one end side holding portion 15 rearward after the tool H2 has completed the tape winding, so that it is possible to reduce a load applied to connection portions between the electric wire W and the connectors C1, C2. In this way, the branch is formed at a necessary position, so that all the wire harness manufacturing steps are completed.

As described above, according to the wire harness manufacturing device in the present embodiment, it is possible to shorten the cycle time for manufacturing one wire harness by causing order of the manufacturing steps to be different from normal order and combining the collective measuring, the collective cutting, and the collective crimping. According to the wire harness manufacturing device in the present embodiment, the tension is adjusted for each electric wire W, and the electric wire can be bundled in a state in which, for example, the electric wire is loosely stretched. Therefore, the tape can be quickly wound and the branch can be formed.

The present invention is not limited to the above-described embodiment, and modifications, improvements, and the like may be made as appropriate. In addition, materials, shapes, dimensions, numerical values, forms, numbers, arrangement locations, and the like of components according to the above-described embodiment can be set freely and are not limited as long as the present invention can be achieved. For example, in the above-described embodiment, the wire harness is manufactured by attaching the six connectors C1 and the four connectors C2 to the ten electric wires W. However, the number of the connectors C1, C2 and the number of the electric wires W can be set freely. In the above-described embodiment, the electric wire and the connector are crimped and connected to each other. However, a connecting method is not limited to the crimping, and the electric wire and the connector may be connected by, for example, laser connecting and press-clamping.

Modification

When a special processing requirement such as a communication line is required for a wire harness to be manufactured, the wire harness manufacturing device can cooperate with other automated processing facilities. For example, a sub-harness in which connectors are attached to both ends of an electric wire is supplied from another facility, and the wire harness manufacturing device can fit the connector on the other end side on the jig plate and the connector of the sub-harness, and then perform processing such as tape winding.

In the wire harness manufacturing device, a component such as a clip can be automatically attached by changing the tool of the robot arm after the branch has been formed. Thereafter, the conduction inspection is executed again to ensure a performance of the wire harness. Since a self-step is completed in each step, it is possible to eliminate a need for an external appearance inspection. The completed wire harness may be automatically packaged using a robot.

The predetermined position (the binding position) for binding is programmed as coordinates on the jig plate, and the control device may derive the coordinates from drawing information.

The other end side holding portion may be movable on the rail. According to this configuration, the jig plate can be reduced in size. Therefore, an operating range of the robot arm can be reduced, and a takt time can be shortened.

In the above-described embodiment, the electric wires stretched over the adjacent rails are bundled. Alternatively, for example, the electric wires of the non-adjacent rails may be bundled by providing a claw on the grip portion and hooking the electric wire on the claw.

Here, characteristics of the embodiment of the wire harness manufacturing device according to the present invention described above will be briefly summarized and listed in the following [1] to [3].

[1] A wire harness manufacturing device comprising:

a jig plate (11);

a first rail and a second rail (13, 13) that are provided in parallel on the jig plate;

a first holding portion (a one end side holding portion 15) that is configured to hold a first connector (C1) and that is movable along the first rail, and a second holding portion (the one end side holding portion 15) that is configured to hold a second connector (C1) and that is movable along the second rail;

an electric wire holding portion (a pressing mechanism 17) configured to hold a first electric wire (W) pulled out from a first reel (R) and a second electric wire (W) pulled out from a second reel (R);

a one end side connection portion (the pressing mechanism 17) configured to connect one end side of each of the first electric wire and the second electric wire to a respective one of the first connector and the second connector;

a cutting portion (the pressing mechanism 17) configured to cut the first electric wire pulled out to a first predetermined position by a movement of the first holding portion and the second electric wire pulled out to a second predetermined position by a movement of the second holding portion;

a third holding portion and a fourth holding portion (the other end side holding portion 19) configured to hold a third connector (C2) and a fourth connector (C2);

the other end side connector (the pressing mechanism 17) configured to connect the other end sides of the cut first electric wire and the cut second electric wire to the third connector and the fourth connector, respectively; and

a binding portion (a tool H2) configured to bind the first electric wire and the second electric wire at a predetermined position,

wherein the binding portion is configured to bind the first electric wire whose tension is adjusted and the second electric wire at the predetermined position by at least the first holding portion moving along the first rail.

According to the wire harness manufacturing device having a configuration of [1] described above, by automatically performing binding of the electric wires in addition to measuring of the electric wires, cutting of the electric wires, and connecting of the electric wires to the connectors, it is possible to shorten a cycle time for manufacturing one wire harness without requiring processing such as manual branch formation and binding. According to the wire harness manufacturing device in the present embodiment, the tension is adjusted for each electric wire W, and the electric wire can be bundled in a state in which, for example, the electric wire is loosely stretched. Therefore, the tape can be quickly wound and the branch can be formed.

[2] The wire harness manufacturing device according to [1],

wherein the first predetermined position is a position based on an electric wire length of the first electric wire,

wherein the second predetermined position is a position based on an electric wire length of the second electric wire, and

wherein the binding portion is configured to bind the first electric wire and the second electric wire whose tension is adjusted by at least the first holding portion moving along the first rail.

According to the wire harness manufacturing device having a configuration of [2] described above, the electric wires can be bundled at the predetermined position determined based on the length from the one end side of each electric wire.

[3] The wire harness manufacturing device according to [1] or [2] described above, further comprising

a conduction inspection unit configured to execute a conduction inspection on the first electric wire to which the first connector and the third connector are connected and on the second electric wire to which the second connector and the fourth connector are connected.

According to the wire harness manufacturing device having a configuration of [3] described above, since a conduction inspection step can be incorporated in the wire harness manufacturing steps, it is not necessary to separately provide an inspection step after a product has been completed.

What is claimed is:

1. A wire harness manufacturing device comprising:
a jig plate;
a first rail and a second rail that are provided in parallel on the jig plate;
a first holding portion that is configured to hold a first connector and that is movable along the first rail, and a second holding portion that is configured to hold a second connector and that is movable along the second rail;
an electric wire holding portion configured to hold a first electric wire pulled out from a first reel and a second electric wire pulled out from a second reel;
a one end side connection portion configured to connect one end side of each of the first electric wire and the second electric wire to a respective one of the first connector and the second connector;
a cutting portion configured to cut the first electric wire pulled out to a first predetermined position by a movement of the first holding portion and the second electric wire pulled out to a second predetermined position by a movement of the second holding portion;
a third holding portion and a fourth holding portion configured to hold a third connector and a fourth connector, respectively;
the other end side connector configured to connect the other end sides of the cut first electric wire and the cut second electric wire to the third connector and the fourth connector, respectively; and
a binding portion configured to bind the first electric wire and the second electric wire at a predetermined position,
wherein the binding portion is configured to bind the first electric wire and the second electric wire whose tension is adjusted by at least the first holding portion moving along the first rail.

2. The wire harness manufacturing device according to claim 1,
wherein the first predetermined position is a position based on an electric wire length of the first electric wire,
wherein the second predetermined position is a position based on an electric wire length of the second electric wire, and
wherein the binding portion is configured to bind the first electric wire and the second electric wire at the predetermined position determined based on a length from the one end side of the first electric wire and a length from the one end side of the second electric wire.
